(19) United States
(12) Patent Application Publication
(10) Pub. No.: US 2025/0015253 A1
(43) Pub. Date: Jan. 9, 2025

(54) METHOD FOR CALENDERING AN ELECTRODE TAPE, AND CALENDERING DEVICE

(71) Applicant: Volkswagen Aktiengesellschaft, Wolfsburg (DE)

(72) Inventors: Ludger BUSSWINKEL, Braunschweig (DE); Chris MEYER, Braunschweig (DE); Tommy PIETSCH, Braunschweig (DE); Sebastian DERSCH, Braunschweig (DE)

(73) Assignee: Volkswagen Aktiengesellschaft, Wolfsburg (DE)

(21) Appl. No.: 18/763,751

(22) Filed: Jul. 3, 2024

(30) Foreign Application Priority Data
Jul. 4, 2023 (DE) 10 2023 206 347.6

(51) Int. Cl. H01M 4/04; G01N 21/86; G01N 21/88

(52) U.S. Cl. CPC H01M 4/0435; G01N 21/86; G01N 21/8851; G01N 2021/8654; G01N 2021/888

(57) ABSTRACT

A method for calendering an electrode tape via a calendering process, in which an electrode tape is passed through a roller gap of a pair of rollers of a calendering device, namely by compressing the electrode tape. During the calendering process a defect detection step is carried out, in which at least one defect of the electrode tape is directly or indirectly detected. If a defect is detected during the defect detection step, the pair of rollers is adjusted from a calendering position of the pair of rollers to an open position of the pair of rollers in an opening step, and this is before the defect reaches the roller gap. The defect detection step and/or the opening step is carried out, preferably automatically or fully automatically, via an open-loop and/or closed-loop control system of the calendering device.

This nonprovisional application claims priority under 35 U.S.C. § 119 (a) to German Patent Application No. 10 2023 206 347.6, which was filed in Germany on Jul. 4, 2023, and which is herein incorporated by reference.

### BACKGROUND OF THE INVENTION

### Field of the Invention

The invention relates to a method for calendering an electrode tape and a calendering device.

### Description of the Background Art

In a generic method for calendering an electrode tape, a calendering process is carried out in which an electrode tape is passed through a roller gap of a pair of rollers of a calendering device. When passing through, the electrode tape is compressed under very high roller pressure between solid steel rollers of the pair of rollers. The electrode tape may have defects due to manufacturing, such as a splice connection or surface defects of the electrode tape. If these defects are passed through the roller gap without further precautions, considerable damage to the pair of rollers can occur due to the high roller pressure. To prevent such damage, the calendering process has so far been monitored manually by a worker. If the worker detects a defect, the worker interrupts the calendering process, adjusts the pair of rollers from a calendering position to an open position, guides the defect through the roller gap, adjusts the pair of rollers to the calendering position and starts the calendering process again.

This has the disadvantage that the method only achieves a very limited overall system effectiveness due to the many manual interruptions.

From DE 11 2019 001 631 T5, which corresponds to US 2021/0114071, a roller press machine, an open-loop and/or closed-loop control system of a roller press machine and an open-loop and/or closed-loop control method of a roller press machine are known. A position sensor detects a leading edge of a workpiece before the leading edge enters a roller gap of the roller press machine.

### SUMMARY OF THE INVENTION

It is therefore an object of the invention to provide a method for calendering an electrode tape with which a higher overall system effectiveness can be achieved as compared to the known method. Another object is to provide a calendering device that makes the process of calendering an electrode tape cost-effective.

According to an example of the invention, proposed is a method for calendering an electrode tape by means of a calendering process, in which an electrode tape is passed through a roller gap of a pair of rollers of a calendering device, namely by compressing the electrode tape, in which calendering process a defect detection step is carried out, in which at least one defect of the electrode tape is directly or indirectly detected, and in which calendering process, if a defect is detected during the defect detection step, the pair of rollers is adjusted from a calendering position of the pair of rollers to an open position of the pair of rollers in one opening step, and this before the defect reaches the roller gap. According to the invention, the defect detection step and/or the opening step is carried out, preferably automatically or fully automatically, by means of an open-loop and/or closed-loop control system of the calendering device. Due to the defect detection step and/or the opening step carried out by means of the open-loop and/or closed-loop control system, neither manual monitoring of the procedure nor manual interruptions are necessary. In addition, the automatic opening step ensures that the defect is free of interfering contours and can therefore be guided through the roller gap without damage to the pair of rollers.

By way of example, it may be provided that indirect detection of the defect is understood to mean that the defect and/or the position of the defect is detected by means of a marking, preferably by means of a marking, preferably by means of a color marking. By way of example, it may be provided that immediate detection of the defect means that the defect and/or the position of the defect is recognized and/or detected by means of a sensor, preferably a CCD sensor, directly and/or on the basis of the defect itself.

Preferably, it may be provided that in the calendering position of the pair of rollers the roller gap can have a calendering gap width and/or that in the open position of the pair of rollers the roller gap has a defect gap width.

Particularly preferably, it may be provided that the defect can be categorized in the defect detection step, wherein the defect is categorized either as hazardous to the roller or as non-hazardous to the roller. If a defect that does not endanger the roller is detected, no opening step and/or no closing step is carried out and the calendering process continues unchanged. This means that the calendering process is interrupted or slowed down not for every defect, but only for a defect that puts the roller at risk. The overall system effectiveness of the method thus depends in an advantageous way only on defects that are also hazardous to rollers.

It may be provided that the open-loop and/or closed-loop control system can have a data storage and that data storage position information on the position of the defect of the electrode tape, preferably in relation to the electrode tape and/or a longitudinal direction of the electrode tape, is stored in the data storage, and that an open-loop and/or closed-loop control unit of the open-loop and/or closed-loop control system retrieves or receives the data storage position information, preferably at the defect detection step and/or for the detection of the defect, as a data storage signal. The data storage position information represents a digital marking, which can be used, for example, to reduce the tape speed of the electrode tape prematurely, preferably before a physical marking, e.g., in the form of a color marking, by which the open-loop and/or closed-loop control system is recognized, preferably detected.

It may be provided that the open-loop and/or closed-loop control system can have a sensor, and that the position of the defect of the electrode tape, preferably in relation to the electrode tape and/or a longitudinal direction of the electrode tape, is recognized, preferably detected, by means of the sensor, and that sensor position information about the position of the defect in the defect detection step is transmitted as a sensor signal from the sensor to the open-loop and/or closed-loop control unit of the open-loop and/or closed-loop control system. The sensor position information represents redundant position information to the data storage position information. This has the advantage of significantly increasing the reliability of defect detection.

The sensor can be formed by a color sensor or a CCD sensor, and that a marking, preferably a color marking, is applied to or parallel to the at least one defect, and that the position of the defect of the electrode tape, preferably in relation to the electrode tape and/or a longitudinal direction of the electrode tape, is preferably detected by means of the color sensor or the CCD sensor on the basis of the marking, preferably the color marking, applied to the defect. The color marking represents a physical marking. The color marking, for example, as compared to general sensory recognition, has the advantage that the color marking can be detected in a simple manner and, above all, with particular process reliability.

As an example, it may be provided that the position of at least one defect can be detected directly by the CCD sensor, preferably in a surface inspection process, wherein it may be preferably provided that the position of the defect is not detected by a marking or color marking, but directly and/or on the basis of the defect itself and/or without a previously applied marking by means of the CCD sensor. As an example, it can be provided that the at least one defect, preferably directly and/or indirectly, is detected by the CCD sensor in front of the roller gap.

By way of example, it may be provided that the marking, preferably the color marking, preferably at least in the case of defects where adhesive tape is at least partially exposed, can be formed by the adhesive tape. This has the advantage that no separate marking, preferably color marking, or additional adhesive sticker on a splice connection is required to mark the splice connection as a defect. Instead, the defect in the form of the splice connection is recognized and/or detected directly on the basis of the adhesive tape and/or its color. The adhesive tape can therefore preferably have the same color as the color marking or an adhesive sticker forming the color marking.

The open-loop and/or closed-loop control system can have an unwind splicer, and that the position of the defect of the electrode tape, preferably in relation to the electrode tape and/or a longitudinal direction of the electrode tape, is recognized, preferably detected, by means of the unwind splicer, and that splice position information about the position of the defect in the defect detection step is transmitted as a splice signal from the unwind splicer to the open-loop and/or closed-loop control unit of the open-loop and/or closed-loop control system. In addition or alternatively, position information can therefore also be determined via the unwind splicer. This further increases the process reliability of defect detection as compared to defect detection based solely on data storage and/or sensor position information.

The data storage position information can be formed by the splice position information. This means that the splice position information can also be stored in the data storage as data storage position information. In this case, the splice position information is transmitted as a splice signal to the data storage and stored there. This has the advantage that there does not necessarily have to be a direct signal connection between the unwind splicer and the open-loop and/or closed-loop control unit.

The open-loop and/or closed-loop control system can have the open-loop and/or closed-loop control unit, and that the data storage position information is transmitted to the control unit as a data storage signal and/or the sensor position information as a sensor signal and/or the splice position information as a splice signal and, preferably the signals, are processed into a control information in the open-loop and/or closed-loop control unit, and that the control information is transmitted as an opening signal to an actuator of the open-loop and/or closed-loop control system, and that the actuator is controlled in the opening step by means of the opening signal in such a way that the pair of rollers is adjusted from the calendering position to the open position by means of the actuator. In the open-loop and/or closed-loop control unit, the position information is therefore further processed depending on availability. During the further processing of the signal, the position information can be advantageously compared with each other and the accuracy of the position determination of the defect can thus be increased.

The actuator can be controlled by the open-loop and/or closed-loop control unit by means of the control signal in such a way that the pair of rollers is adjusted to the open position before at least one defect reaches the roller gap, and/or that the actuator is controlled by the open-loop and/or closed-loop control unit by means of the control signal in such a way that the pair of rollers is adjusted to the open position after a defect leading tape section of the electrode tape has reached the roller gap. The actuator enables particularly cost-effective adjustability of the roller gap.

The defective leading tape section of the electrode tape can be directly adjacent to the defect and/or reaches the roller gap in front of the defect.

The defective leading tape section can be uncompressed or not completely compressed after passing through the roller gap.

The defective leading tape section, preferably viewed in the travel direction and/or parallel to the travel direction, can have a leading tape section length, and that the size of the leading tape section length, preferably at a tape speed of the electrode tape in a range of 25 m/min to 150 m/min, in a range of 5 cm to 150 cm, preferably in a range of 10 cm to 30 cm, is particularly preferable at 20 cm.

In particular, the 20 cm length of the leading tape section is a good compromise between low electrode tape waste and ensuring that no damage to the pair of rollers occurs.

A path speed of the electrode tape can be reduced by means of the open-loop and/or closed-loop control system from a calendering tape speed to a defect tape speed before the defect reaches the roller gap. Alternatively or additionally, it may be provided that the path speed of the electrode tape is reduced by means of the open-loop and/or closed-loop control system from the calendering tape speed to the defect tape speed after which the defective leading tape section has reached the roller gap. By reducing the path speed, the amount of waste of electrode tape in the uncalendered state before and after the defect can be reduced.

The method can have a closing step, and that during the closing step the open-loop and/or closed-loop control unit generates a closing signal and transmits it to the actuator, and that the actuator is controlled in the closing step by means of the closing signal in such a way that the pair of rollers is adjusted from the open to the calendering position by means of the actuator, wherein it may be preferably provided that the actuator is controlled by the open-loop and/or closed-loop control unit by means of the closing signal in such a way that the pair of rollers is adjusted to the calendering position as soon as a defective trailing tape section of the electrode tape has left the roller gap, and/or it may be preferably provided that the actuator is controlled by the open-loop and/or closed-loop control unit by means of the closing signal, that the pair of rollers is adjusted from the open position to the calendering position, after the at least one defect has left the roller gap. The closing step enables the calendering process, after the defect passes through the roller gap, to be continued automatically. The duration of the interruptions is therefore reduced to a minimum, so that a high overall system effectiveness can be achieved with the method.

The closing step can be carried out, preferably automatically or fully automatically, by means of the open-loop and/or closed-loop control system of the calendering device. The method can therefore be carried out fully automatically.

The defective trailing tape section of the electrode tape can be directly adjacent to the defect and/or reaches the roller gap after the defect.

The defective trailing tape section can be uncompressed or not completely compressed after passing through the roller gap.

It may be preferably provided that the defective trailing tape section of the electrode tape can have a trailing tape section length, and that the magnitude of the trailing tape section length is in a range of 5 cm to 150 cm, preferably in a range of 10 cm to 30 cm, especially preferably at 20 cm. In particular, the trailing tape section length of 20 cm is a good compromise between low electrode tape waste and ensuring that no damage occurs to the pair of rollers.

A path speed of the electrode tape can be reduced to zero by means of the open-loop and/or closed-loop control system before the start and/or completion of the closing step, preferably from the calendering tape speed or from the defect tape speed, wherein it may be preferably provided that the electrode tape is increased from zero to the calendering path speed by means of the open-loop and/or closed-loop control system after completion of the closing step.

A calendering device, preferably for carrying out a method as described above, is also proposed, with a pair of rollers through which an electrode tape can be passed in a calendering process, preferably in a continuous process, with compression of the electrode tape, and an open-loop and/or closed-loop control system. The open-loop and/or closed-loop control system is suitable and/or designed to carry out a defect detection step, preferably automatically or fully automatically, during the calendering process and to detect at least one defect on the electrode tape directly or indirectly. Alternatively or additionally, if a defect is detected, the open-loop and/or closed-loop control system is suitable and/or designed to adjust the pair of rollers from a calendering position of the pair of rollers, preferably automatically or fully automatically, from a calendering position of the pair of rollers, in which the roller gap preferably has a calendering gap width, to an open position of the pair of rollers in which the roller gap preferably has a defect gap width. The same advantages apply to the calendering device as to the method.

The electrode tape can have a carrier element and at least one coating. It may be particularly preferably provided that the carrier element is formed by a carrier foil, wherein it may be preferably provided that the carrier foil exclusively or at least partially contains aluminum and/or copper.

As an example, it can be provided that the coating has active material and/or binder.

As an example, it can be provided that the calendering gap width is adjusted so that the thickness of the compressed electrode tape is 0.05 mm to 0.5 mm.

The designations upper and lower roller may not be understood as spatial directions, but that the lower roller can be described only as a first roller, preferably arranged in some way, and the upper roller only as a second roller, preferably arranged in some way.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows in a schematic side-section view, a calendering device;

FIGS. 2 and 3 show in each case in a schematic side view, a defect in an electrode tape;

FIG. 4 shows in a schematic side view, a coating defect of the electrode tape; and

FIGS. 5 and 6 show in each case in a schematic side view, a splice connection of the electrode tape.

### DETAILED DESCRIPTION

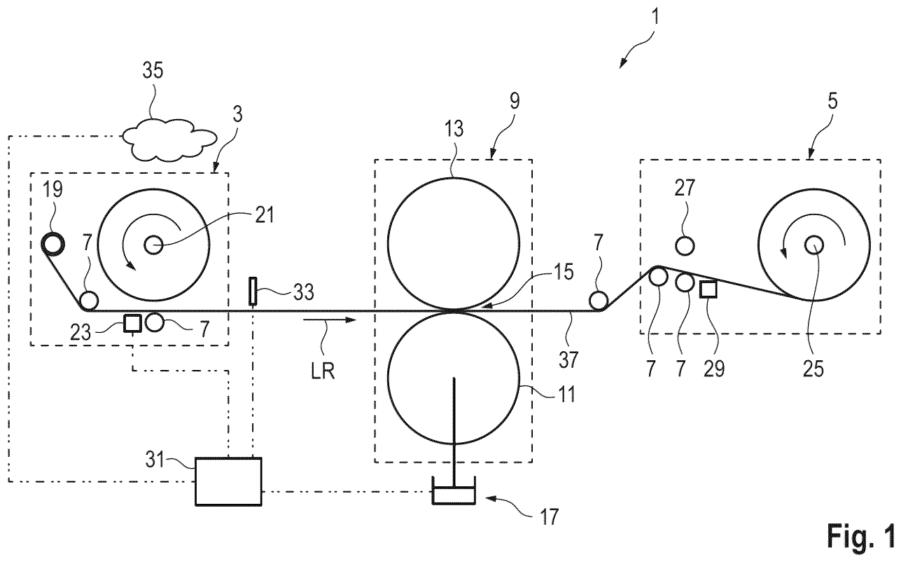

FIG. 1 shows a calendering device 1. The calendering device 1 has an unwinding unit 3 and a winding unit 5. Furthermore, the calendering device 1 has guide rollers 7 and a pair of rollers 9. The pair of rollers 9 has a lower roller 11 formed by a cylindrical metal roller and an upper roller 13 formed by a cylindrical metal roller. The lower roller 11 is connected to an actuator 17 of the calendering device 1, here as an example to a hydraulic actuator. Alternatively, however, it is of course also possible to design the actuator 17 as an example as an electromechanical actuator with the described or another embodiment of the calendering device 1.

The unwinding unit 3 has an unwind turret winder with a first unwind core 19 and a second unwind core 21. In addition, an automatic unwind splicer 23 is provided, which is located in the unwind turret winder. The rewind unit 5 has a rewind turret winder with a first rewind core 25 and a second rewind core 27, as well as an automatic rewind splicer 29.

The calendering device 1 has an open-loop and/or closed-loop control system. The open-loop and/or closed-loop control system has an open-loop and/or closed-loop control unit 31, a sensor 33, the actuator 17, the unwind splicer 23 and a data storage 35, which is designed as cloud storage here only by way of example. The sensor 33 is, here only by way of example, embodied by a color sensor. Alternatively, in the described or another embodiment of the calendering device 1, it is of course also possible to design the sensor 33 as a CCD sensor, i.e., as a charge-coupled-device sensor.

The open-loop and/or closed-loop control unit 31 is in signal connection with the sensor 33 and is in signal connection with the data storage 35. In addition, the open-loop and/or closed-loop control unit 31 is in signal connection with the actuator 17. The open-loop and/or closed-loop control unit 31 is also in signal connection with the unwind splicer 23. The signal connections are illustrated in FIG. 1 by the lines emanating from the open-loop and/or closed-loop control unit 31, preferably dash-dot lines.

Between the lower roller 11 and the upper roller 13, a roller gap 15 is provided. The lower roller 11 limits the roller gap 15 downwards and the upper roller 13 limits the roller gap 15 upwards. The roller gap 15 has an adjustable gap width. By adjusting the lower roller 11 by means of the actuator 17 controlled by the open-loop and/or closed-loop control unit 31, the gap width can be adjusted from a calendering gap width, at which the pair of rollers 9 is in a calendering position, to a defect gap width, at which the pair of rollers 9 is in an open position, and vice versa.

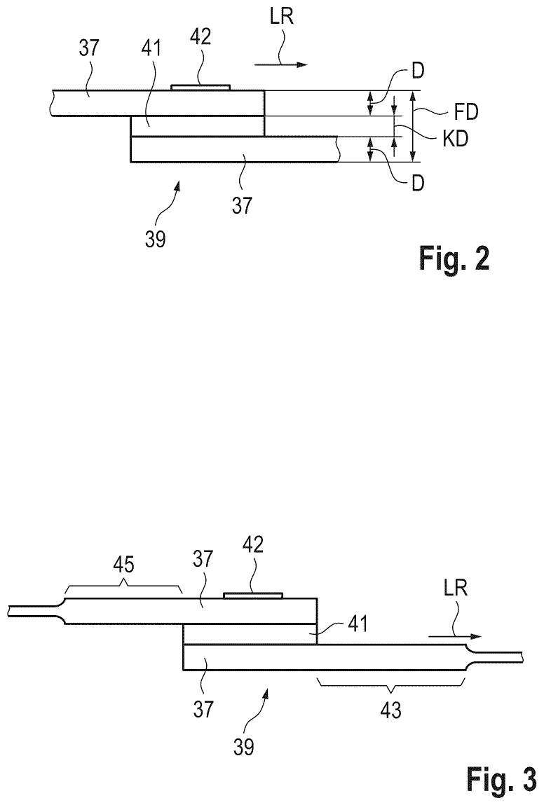

The magnitude of the calendering gap width is less than the magnitude of the tape thickness D of the electrode tape 37 in an uncalendered state, as shown in FIG. 2. The magnitude of the defect gap width is preferably greater than the defect thickness FD, shown in FIG. 2, of a defect 39, shown enlarged in FIG. 2.

The defect 39 in FIG. 2 is only formed by way of example as a splice connection. By means of the splice connection, the electrode tape 37 of different electrode coils is connected to each other by means of an intermediate layer of a double-sided adhesive tape 41 between one end of the electrode tape 37 of a first electrode coil arranged on the first unwind core 19 and one end of the electrode tape 37 of a second electrode coil arranged on the second unwind core 21. In the area of the splice connection, the defect thickness FD is obtained by adding twice the tape thickness D of the electrode tape 37 and the thickness KD of the adhesive tape 41. As an alternative to a splice connection, the defect 39 can also be formed by way of example by a surface defect and/or by a material agglomerate and/or by a bubble.

The calendering device 1 is designed and suitable for compressing the electrode tape 37 from an uncalendered state to a calendered state in a single process. The electrode tape 37 has a carrier layer, e.g., formed by a carrier tape containing aluminum or copper, as well as a coating, which, e.g., among other things, has an active material and e.g., a binder. In the uncalendered state of the electrode tape 37, for example, the porosity may be too high, which is reduced to an optimum by calendering and/or compressing. The electrode tape 37 in the calendered and/or compressed state is used for the production of electrodes for, e.g., lithium-ion batteries and enables higher energy densities as compared to electrodes made of electrode tape in an uncalendered state.

In addition to the porosities mentioned only as examples, the electrode tape 37 here only has the defect 39 as an example. If the roller gap 15 is adjusted to the calendering gap width and the electrode tape 37 with the defect 39 is passed through the roller gap 15, the pair of rollers 9 is damaged. For example, the damage can include deforming at least the lower roller 11 or at least the upper roller 13 or deforming both the lower roller 11 and the upper roller 13.

In order to prevent damage to the pair of rollers 9 caused by the defect 39, the pair of rollers 9 is adjusted fully automatically from the calendering position of the pair of rollers 9 to the open position of the pair of rollers 9 by means of the open-loop and/or closed-loop control system of the calendering device 1 and before the defect 39 has reached the roller gap 15. When the pair of rollers 9 is opened, the defect 39 can pass through the roller gap without interfering contours and no damage to the pair of rollers 9 occurs. Once the defect 39 has then passed the pair of rollers 9 in the direction of travel LR, the pair of rollers 9 is adjusted from the open position back to the calendering position by means of the open-loop and/or closed-loop control system.

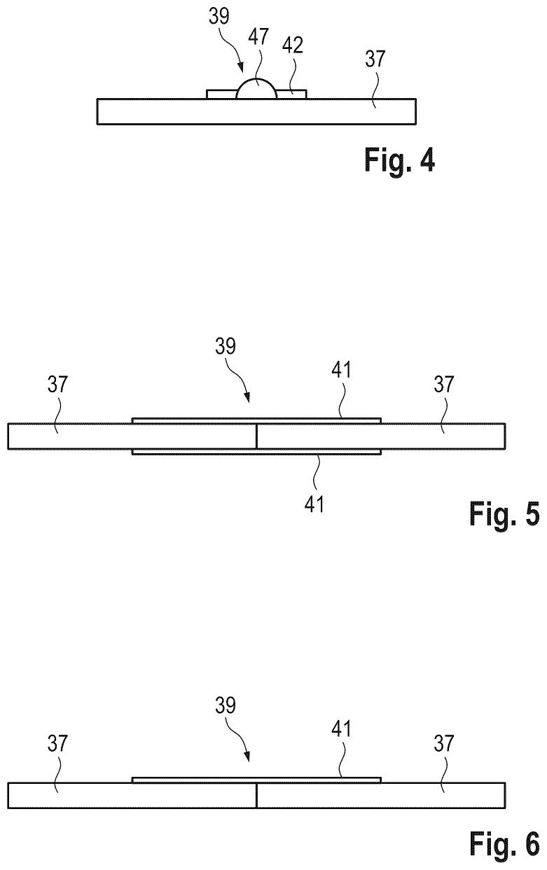

In FIG. 4, the defect 39 is only exemplified by a coating defect 47 in the form of a bubble. The coating defect 47 or bubble cannot be compressed by the rollers of the pair of rollers 9 without damaging the pair of rollers 9. Therefore, in the case of such coating defects 47, the roller gap 15 is also opened.

In FIGS. 5 and 6, the defect 39 is formed by different types of splice connections. In FIG. 5, a strip of adhesive tape 41 is applied to a top of the splice connection between the electrode tape 37 and a strip of adhesive tape 41 is applied to a bottom of the splice connection between the electrode tape 37. In these cases, the adhesive tape 41 is exposed and can be detected by the sensor 33, preferably by the color sensor. Since the adhesive tape 41 is exposed and is detected by the sensor 33, preferably by the color sensor, the adhesive tape 41 fulfils a dual function in addition to connecting the electrode tape of the two electrode coils, namely that the adhesive tape 41 also forms a detectable marking of the splice connection and thus of the defect 39 by means of the sensor 33. A color marking, preferably an adhesive sticker, is then not required, but can optionally be provided additionally. The same applies to the splice connection shown in FIG. 6, which differs from the splice connection of FIG. 5 only in that the adhesive tape 41 is only glued to the top of the splice connection, whereas in the splice connection of FIG. 6 no adhesive tape is provided at the bottom of the splice connection.

The method is explained in detail below on the basis of FIG. 1. The method has a preparation step and a calendering process. In the preparation step, the calendering device 1 and the electrode tape 37 are prepared. In the calendering process, the electrode tape 37 is passed through the roller gap 15 of the pair of rollers 9 of the calendering device 1 at a tape speed of the electrode tape 37, namely by compressing the electrode tape 37 from an uncalendered state to a calendered, i.e., compressed, state.

During the calendering process, a defect detection step is carried out fully automatically by means of the open-loop and/or closed-loop control system, in which the defect 39 is detected. In addition, during the calendering process, if a defect 39 was detected during the defect detection step, the pair of rollers 9 is fully automatically adjusted by the open-loop and/or closed-loop control system in an opening step from the calendering position of the pair of rollers 9 to the open position of the pair of rollers 9 before the defect 39 reaches the roller gap 15.

The defect 39 is detected in the defect detection step by means of digital recognition and/or by means of physical recognition. In the case of digital recognition, the data storage 35 stores data storage position information about the position of the defect 39, preferably in relation to electrode tape 37. The data storage position information is retrieved and received by the open-loop and/or closed-loop control unit 31 of the open-loop and/or closed-loop control system as a data storage signal. The data storage position information for the position of the defect 39 can be saved in the data storage, for example, in advance manually by a worker or preferably by an automatic surface inspection by, e.g., a camera system with CCD sensor. This can be done, for example, in a coating and/or slitting process for the production of the electrode tape 37. A surface inspection in a process step upstream of the calendering is useful in order to detect the defects as early as possible after they have occurred, so that immediate action can be taken in the event of an unexpectedly high number of defects occurring.

In the case of physical detection, the position of the defect 39 is detected by means of the sensor 33 embodied by the color sensor. For this purpose, a color marking is applied to the defect 39 or parallel to the defect 39 at a defined point on the electrode tape 37, preferably at the edge of the electrode tape 37 or even with a protrusion beyond the edge of the electrode tape 37, which is shown in FIGS. 2 and 3 only by way of example as adhesive stickers 42. The color marking or the adhesive sticker 42 are purely optional. As an alternative to the adhesive sticker, the color marking in this or in an embodiment of the method can of course also be formed, e.g., by an application of paint. The adhesive sticker can be applied to the defect 39 or parallel to defect 39 at a defined location on the electrode tape 37, preferably at the edge of the electrode tape 37, e.g., in advance manually by a worker and/or by an automatic surface inspection by, e.g., a camera system with CCD sensor and an automatic defect marking system. This can be done, for example, in a coating and/or slitting process for the production of the electrode tape 37. The surface inspection in a process step upstream of the calendering is useful in order to detect the defects as early as possible after they have occurred, so that immediate action can be taken in the event of an unexpectedly high number of defects occurring.

The position of the defect 39 is detected by the color sensor on the basis of the color marking applied to the defect 39 or parallel to the defect 39 at a defined location on the electrode tape 37, preferably at the edge of the electrode tape 37. Subsequently, sensor position information about the position of the defect 39, preferably in relation to the electrode tape 37, is transmitted as a sensor signal from the sensor 33 to the open-loop and/or closed-loop control unit 31 of the open-loop and/or closed-loop control system.

In the case, as described here only by way of example, where the defect 39 is formed by a splice connection, the unwind splicer 23 transmits splice position information corresponding to the position of the splice connection, preferably in relation to the electrode tape 37 or in relation to the rest of the electrode tape 37, in the form of a splice signal to the open-loop and/or closed-loop control system 31 when performing a splicing process.

The open-loop and/or closed-loop control unit 31 thus has the data storage position information and the sensor position information and the splice position information at its disposal. In principle, it would be sufficient for the method that the open-loop and/or closed-loop control unit 31 has only one or only two of the three pieces of position information mentioned available. However, the provision of all three pieces of position information due to redundancy of the information significantly increases the process reliability of the method and also its accuracy.

In the open-loop and/or closed-loop control unit 31, the data storage position information and the sensor position information are processed into a control information for the actuator 17. The control information is transmitted to the actuator by the open-loop and/or closed-loop control unit 31 as an opening signal. In the opening step, the actuator 17 is controlled by means of the opening signal in such a way that the pair of rollers 9 is adjusted from the calendering position to the open position by means of the actuator 17 before the defect reaches the roller gap.

In principle, it is also possible to maintain and/or provide a safety distance in front of the defect 39. For this purpose, the actuator 17 is controlled by the open-loop and/or closed-loop control unit 31 by means of the control signal in such a way that the adjustment of the pair of rollers 9 to the open position begins after a defective leading tape section 43 of the electrode tape 37 has reached the roller gap 15.

As shown in FIG. 3, the defective leading tape section 43 of the electrode tape 37 is directly adjacent to the defect 39 and reaches the roller gap 15, viewed in the direction of travel LR, before, in particular earlier in time before, the defect 39. As also shown in FIG. 3, the defective leading tape section 43 is uncompressed or partially compressed after passing through the roller gap 15. The defective leading tape section 43, preferably viewed in the direction of travel LR and/or viewed parallel to the direction of travel LR, has a leading tape section length of only 20 cm, for example.

Before the defect 39 reaches the roller gap 15, a path speed of the electrode tape 37 is already reduced by the open-loop and/or closed-loop control system from a calendering tape speed to a defect tape speed. In this way, the waste in the form of uncalendered electrode tape 37 can be reduced before and after the defect 39. In principle, it is possible that the reduction of the path speed of the electrode tape by means of the open-loop and/or closed-loop control system from the calendering tape speed to the defect tape speed already begins after the defective leading tape section 43 has reached the roller gap 15. It is also possible to increase the tape speed when the roller gap 15 is open for long electrode tape sections with defects, e.g., by 200 m.

The method also has a closing step. During the closing step, after the defect 39 and/or at least partially the defective trailing tape section has passed and/or left the roller gap 15, the open-loop and/or closed-loop control unit 31 generates a closing signal and transmits the closing signal to the actuator 17.

The actuator 17 is controlled by the open-loop and/or closed-loop control unit 31 in the closing step by means of the closing signal in such a way that the pair of rollers 9 is adjusted to the calendering position as soon as the defective trailing tape section 45 of the electrode tape 37 has at least largely left the roller gap 15. In addition, the actuator 17 is controlled by the open-loop and/or closed-loop control unit 31 by means of the closing signal in such a way that the pair of rollers 15 is adjusted from the open position to the calendering position after the defect 39 has left the roller gap 15. The closing step is carried out fully automatically by means of the open-loop and/or closed-loop control system of the calendering device.

The defective trailing tape section 45 of the electrode tape 37 is directly adjacent to the defect 39 and passes and/or reaches the roller gap 15 only after the defect 39. After passing through the roller gap 15, the defective trailing tape section 45 is uncompressed, preferably only partially compressed, as shown in FIG. 3. The defective trailing tape section 45 of the electrode tape 37 has a trailing tape section length. Just as an example, the magnitude of the trailing tape section length is 20 cm.

FIG. 3 shows the defective leading tape section 43 and the defective trailing tape section 45 and the defect 39 in a state after which the defective leading tape section 43 and the defective trailing tape section 45 and the defect 39 have passed the roller gap 15.

Before the start of the closing step, the tape speed of the electrode tape 37 is reduced to zero from the defect tape speed by means of the open-loop and/or closed-loop control system and the electrode tape 37 is thus stopped. This is to prevent the tearing of the electrode tape 37 when closing the roller gap 15. After completion of the closing step, the tape speed of the electrode tape 37 is then increased from zero back to the calendering tape speed.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for calendering an electrode tape, the method comprising:
performing a calendering process, wherein an electrode tape is passed through a roller gap of a pair of rollers of a calendering device by compressing the electrode tape;
performing, in the calendering process, a defect detection step in which at least one defect of the electrode tape is directly or indirectly detected;
determining, in the calendering process, if a defect is detected during the defect detection step;
adjusting the pair of rollers before the defect reaches the roller gap, in an opening step from a calendering position of the pair of rollers to an open position of the pair of rollers; and
performing the defect detection step and/or the opening step automatically or fully automatically via an open-loop and/or closed-loop control system of the calendering device.

2. The method according to claim 1, wherein the open-loop and/or closed-loop control system has a data storage and wherein data storage position information about the position of the defect of the electrode tape, in relation to the electrode tape and/or a longitudinal direction of the electrode tape, is stored in the data storage, and wherein an open-loop and/or closed-loop control unit of the open-loop and/or closed-loop control system retrieves and/or receives the data storage position information at the defect detection step and/or for the detection of the defect, as a data storage signal.

3. The method according to claim 1, wherein the open-loop and/or closed-loop control system has a sensor, and wherein the position of the defect of the electrode tape, in relation to the electrode tape and/or a longitudinal direction of the electrode tape, is recognized, preferably detected, via the sensor, and wherein sensor position information about the position of the defect is transmitted in the defect detection step as a sensor signal from the sensor to the open-loop and/or closed-loop control unit of the open-loop and/or closed-loop control system.

4. The method according to claim 3, wherein the sensor is formed by a color sensor or a CCD sensor, and wherein a marking or a color marking is applied to or parallel to the at least one defect, and wherein the position of the defect of the electrode tape, in relation to the electrode tape and/or a longitudinal direction of the electrode tape, is recognized or detected by the color sensor or the CCD sensor on the basis of the marking applied to the defect.

5. The method according to claim 1, wherein the open-loop and/or closed-loop control system is an unwind splicer, and wherein the position of the defect of the electrode tape in relation to the electrode tape and/or a longitudinal direction of the electrode tape is recognized or detected by the unwind splicer, and wherein splice position information about the position of the defect in the defect detection step is transmitted as a splice signal from the unwind splicer to the open-loop and/or closed-loop control unit of the open-loop and/or closed-loop control system.

6. The method according to claim 2, wherein the open-loop and/or closed-loop control system comprises the open-loop and/or closed-loop control unit and wherein the data storage position information is transmitted as a data storage signal and/or the sensor position information as a sensor signal and/or the splice position information as a splice signal to the open-loop and/or closed-loop control unit, and wherein the signals are processed in the open-loop and/or closed-loop control unit into control information, and wherein the control information is transmitted as an opening signal to an actuator of the open-loop and/or closed-loop control system, and wherein the actuator is controlled in the opening step by the opening signal such that the pair of rollers is adjusted from the calendering position to the open position by the actuator.

7. The method according to claim 6, wherein the actuator is controlled by the open-loop and/or closed-loop control unit by the control signal such that the pair of rollers is adjusted to the open position before the at least one defect reaches the roller gap, and/or wherein the actuator is controlled by the open-loop and/or closed-loop control unit by the control signal such that the pair of rollers is adjusted to the open position, after a defect leading tape section of the electrode tape has reached the roller gap.

8. The method according to claim 1, wherein a tape speed of the electrode tape is reduced by the open-loop and/or closed-loop control system from a calendering tape speed to a defect tape speed before the defect reaches the roller gap.

9. The method according to claim 1, wherein the method has a closing step, and wherein, during the closing step the open-loop and/or closed-loop control unit generates a closing signal and transmits it to the actuator, and wherein the actuator is controlled in the closing step by the closing signal such that the pair of rollers is adjusted from the open to the calendering position by the actuator, wherein, the actuator is controlled by the open-loop and/or closed-loop control unit by the closing signal such that the pair of rollers is adjusted to the calendering position as soon as a defective trailing tape section of the electrode tape has left the roller gap and/or the actuator is controlled by the open-loop and/or closed-loop control unit by the closing signal such that the pair of rollers is adjusted from the open position to the calendering position after the at least one defect has left the roller gap.

10. A calendering device to carry out the method according to claim 1, the calendaring comprising:
a pair of rollers through which an electrode tape is adapted to be passed in a calendering process or in an endless process, with compression of the electrode tape; and
an open-loop and/or closed-loop control system adapted to carry out a defect detection step automatically or fully automatically during the calendering process and to directly or indirectly detect at least one defect on the electrode tape,
wherein the open-loop and/or closed-loop control system adjusts the pair of rollers automatically or fully automatically from a calendering position of the pair of rollers to an open position of the pair of rollers when a defect is detected.
